(19) United States
(12) Patent Application Publication
(10) Pub. No.: US 2026/0303858 A1
(43) Pub. Date: Oct. 1, 2026

(54) REPRODUCIBLE LEARNING-BASED POINT CLOUD CODING

(71) Applicant: InterDigital VC Holdings, Inc., Wilmington, DE (US)

(72) Inventors: Muhammad Asad Lodhi, Highland Park, NJ (US); Jiahao Pang, Plainsboro, NJ (US); Junghyun Ahn, New York, NY (US); Dong Tian, Boxborough, MA (US)

(21) Appl. No.: 19/094,753

(22) Filed: Mar. 28, 2025

(51) Int. Cl. H04N 19/54; H04N 19/124; H04N 19/91; H04N 19/96

(52) U.S. Cl. CPC H04N 19/54; H04N 19/124; H04N 19/91; H04N 19/96

(57) ABSTRACT

Some embodiments of a method may include: decoding a motion feature from a motion bitstream; obtaining one or more reference point cloud frames; determining a predicted feature based on the motion feature and the one or more reference point cloud frames; obtaining a feature safeguard bitstream; decoding feature safeguard information from the feature safeguard bitstream; decoding a first feature representing an occupancy of a child level based on the feature safeguard information; determining a second feature based on the first feature and the predicted feature; and decoding a tree voxel occupancy status of the child level via the second feature.

### INCORPORATION BY REFERENCE

The present application incorporates by reference in their entirety the following applications: U.S. Non-Provisional patent application Ser. No. 18/637,370, entitled “REPRODUCIBLE LEARNING-BASED POINT CLOUD CODING” and filed Apr. 16, 2024 (“370 application”); U.S. Non-Provisional patent application Ser. No. 18/784,466, entitled “END-TO-END LEARNING-BASED DYNAMIC POINT CLOUD CODING FRAMEWORK” and filed Jul. 25, 2024 (“466 application”); U.S. Non-Provisional patent application Ser. No. 19/088,367, entitled “PROTECTION MASK CODING FOR REPRODUCIBLE LEARNING-BASED COMPRESSION” and filed Mar. 24, 2025 (“367 application”).

### BACKGROUND

The present application is related to point clouds.

### SUMMARY

A first example method in accordance with some embodiments may include: decoding a motion feature from a motion bitstream; obtaining one or more reference point cloud frames; determining a predicted feature based on the motion feature and the one or more reference point cloud frames; obtaining a feature safeguard bitstream; decoding feature safeguard information from the feature safeguard bitstream; decoding a first feature representing an occupancy of a child level based on the feature safeguard information; determining a second feature based on the first feature and the predicted feature; and decoding a tree voxel occupancy status of the child level via the second feature.

Some embodiments of the first example method may further include: obtaining a motion safeguard bitstream; decoding motion safeguard information from the motion safeguard bitstream, wherein decoding the motion feature from the motion bitstream is based on the motion safeguard information.

Some embodiments of the first example method may further include: obtaining a probability safeguard bitstream; and decoding probability safeguard information from the probability safeguard bitstream, wherein decoding the tree voxel occupancy status of the child level via the second feature is based on the probability safeguard information.

For some embodiments of the first example method, the feature safeguard information includes learned quantization boundary versions of distribution parameters associated with a point cloud.

For some embodiments of the first example method, the feature safeguard information includes learned quantization boundaries.

For some embodiments of the first example method, decoding the motion feature is based on one or more non-uniform quantization rules.

For some embodiments of the first example method, decoding the tree voxel occupancy status of the child level includes: estimating occupancy probabilities using the second feature; obtaining an occupancy bitstream; and performing arithmetic decoding of the occupancy bitstream based on the estimated occupancy probabilities.

Some embodiments of the first example method may further include obtaining a probability safeguard bitstream, wherein performing arithmetic decoding of the occupancy bitstream is further based on the probability safeguard bitstream.

A first example apparatus in accordance with some embodiments may include: a processor; and a memory storing instructions operative, when executed by the processor, to cause the apparatus to: decode a motion feature from a motion bitstream; obtain one or more reference point cloud frames; determine a predicted feature based on the motion feature and the one or more reference point cloud frames; obtain a feature safeguard bitstream; decode feature safeguard information from the feature safeguard bitstream; decode a first feature representing an occupancy of a child level based on the feature safeguard information; determine a second feature based on the first feature and the predicted feature; and decode a tree voxel occupancy status of the child level via the second feature

A second example method in accordance with some embodiments may include: determining a motion feature from a current point cloud and one or more reference point cloud frames; determining a predicted feature based on the motion feature; encoding the motion feature into a motion bitstream; determining a first feature representing the occupancy of a child level; determining a second feature based on the first feature and the predicted feature; performing a protection mechanism to obtain a feature safeguard information and a safeguarded second feature; encoding the feature safeguard information into a feature safeguard bitstream; and encoding the safeguarded second feature into the feature safeguard bitstream.

Some embodiments of the second example method may further include: performing a protection mechanism to obtain motion safeguard information and a safeguarded motion feature; encoding the motion safeguard information into a motion safeguard bitstream; and encoding the safeguarded motion feature into a bitstream.

Some embodiments of the second example method may further include: performing a protection mechanism to obtain probability safeguard information and a safeguarded occupancy probability; encoding the probability safeguard information into a probability safeguard bitstream; and encoding a tree voxel occupancy status of the child level based on the safeguarded occupancy probability.

For some embodiments of the second example method, the feature safeguard information includes learned quantization boundary versions of distribution parameters associated with the current point cloud.

For some embodiments of the second example method, the feature safeguard information includes learned quantization boundaries.

For some embodiments of the second example method, the protection mechanism includes using learned quantization boundaries associated with a non-uniform quantization.

For some embodiments of the second example method, encoding the motion feature includes: performing a non-uniform quantization of the motion feature; and encoding the quantized motion feature into the motion bitstream.

Some embodiments of the second example method may further include encoding the occupancy status of the child level voxel by encoding the second feature into the bitstream.

For some embodiments of the second example method, encoding the occupancy status of the child voxels includes: determining a third feature based on the second feature and the predicted feature; determining occupancy probabilities of the child voxels to be encoded; and encoding the occupancy status of the child voxels with the occupancy probabilities in an occupancy bitstream using an arithmetic encoder.

For some embodiments of the second example method, encoding of the occupancy status is further based on a safeguarded occupancy probability.

For some embodiments of the second example method, the protection mechanism is based on assessed risk associated with one or more features of the current point cloud.

### BRIEF DESCRIPTION OF THE DRAWINGS

The following detailed description will be better understood when read in conjunction with the appended drawings, in which there are shown examples of one or more of the multiple embodiments of the present application. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a flowchart illustrating an example encoding process according to some embodiments.

FIG. 3 is a flowchart illustrating an example decoding process according to some embodiments.

FIG. 4 is a schematic illustration showing an example matching of raw values with quantized values according to some embodiments.

FIG. 5 is a process diagram illustrating an example processing of a level with feature-based coding in inter point cloud compression according to some embodiments.

FIG. 6 is a process diagram illustrating an example processing of a level with octree-based coding in inter point cloud compression according to some embodiments.

FIG. 7A is a process diagram illustrating an example feature encoder according to some embodiments.

FIG. 7B is a process diagram illustrating an example feature decoder according to some embodiments.

FIG. 8A is a process diagram illustrating an example feature encoder with safeguarding according to some embodiments.

FIG. 8B is a process diagram illustrating an example feature decoder with safeguarding according to some embodiments.

FIG. 9A is a process diagram illustrating an example motion encoder according to some embodiments.

FIG. 9B is a process diagram illustrating an example motion decoder according to some embodiments.

FIG. 10A is a process diagram illustrating an example motion encoder with safeguarding according to some embodiments.

FIG. 10B is a process diagram illustrating an example motion decoder with safeguarding according to some embodiments.

FIG. 11A is a process diagram illustrating an example occupancy encoder according to some embodiments.

FIG. 11B is a process diagram illustrating an example occupancy decoder according to some embodiments.

FIG. 12A is a process diagram illustrating an example occupancy encoder with safeguarding according to some embodiments.

FIG. 12B is a process diagram illustrating an example occupancy decoder with safeguarding according to some embodiments.

FIG. 13 is a flowchart illustrating an example decoding process according to some embodiments.

FIG. 14 is a flowchart illustrating an example encoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present application, certain terminology is used herein for convenience only and should not be considered as limiting such embodiments. In the drawings, the same reference numerals are employed for designating the same elements throughout the several figures and the present description.

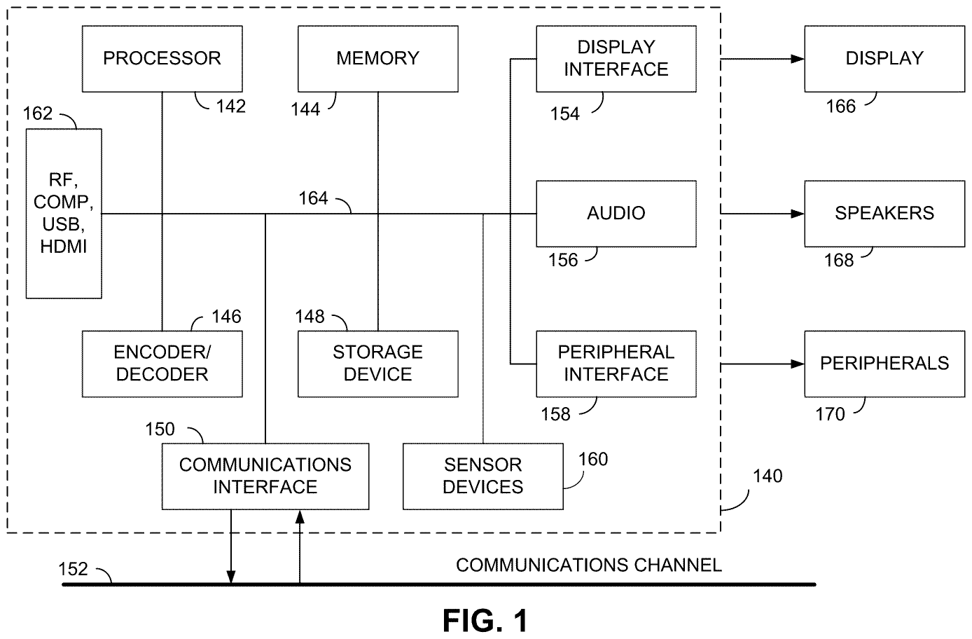

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (I2C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation, and understanding of input signals, such as point clouds.

For some embodiments, this application specifies the blocks/outputs in a network that may be protected for reproducibility in a full point cloud compression system for ensuring decoding reproducibility. Decoding reproducibility refers to minimum protection under which the entropy coding may run properly without crashing and may produce an output with reasonable quality. To achieve this protection, the outputs of the hyperprior synthesis in feature and motion coding, as well as the output of probability estimation, are protected so that the respective entropy encoding and decoding may produce the exact same outputs.

Point cloud data is a universal data format used across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020, and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when storage and transmission of the data are used in related scenarios.

Furthermore, point clouds may represent a sequential scan of the same scene, which contains multiple moving objects. They are called dynamic point clouds, while static point clouds may be captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z). The set of 3D positions illustrates the geometry of the object/scene from which the point cloud is captured. Additionally, each point of the point cloud may be associated with some attributes, depending on the application. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer, while in standard TV, the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings, in which objects, like statues or buildings, are scanned in 3D to share the spatial configuration of the object without sending or visiting the statues or buildings. Also, point clouds offer a way to ensure preservation of knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data includes discrete samples of the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data is composed of two components: geometry information and attribute information, the compression of point clouds may be classified into two categories: geometry coding and attribute coding.

Examples of existing learning-based point cloud geometry compression techniques include deep octree coding and end-to-end feature-based geometry coding. With deep octree coding, neural network-based models are utilized to estimate the occupancy probabilities. Such estimated probabilities may be used to help the arithmetic coder to encode or decode a binary flag indicating whether a child octree voxel is occupied or empty.

Inference reproducibility is a well-known problem. Neural network models may produce results with minor differences when they run on different hardware or software platforms or when they run multiple times. When these neural network models are used for entropy encoding and decoding, a slightly different output may be a severe problem for the entropy encoder and decoder. This issue will not only output a different point cloud but may crash a decoding process. Reproducibility may be ensured in certain blocks in compression by producing an additional protection bitstream for risky entries. For some embodiments, this application specifies the blocks/outputs that may be protected within a full point cloud compression system.

Some technologies exist to help relieve the reproducibility challenge of a neural network. Three related technologies are briefly described in this section. For the first two technologies, as understood, unless the hardware and software platform are strictly aligned, these techniques cannot fully achieve the reproducibility.

### Quantization

Quantization reduces the computational and memory costs of running inference by representing numerical values (weights and activations) using low-precision data types (e.g., 8-bit integers) instead of traditional 32-bit floating-point data types. Gholami, A., et al., A Survey of Quantization Methods for Efficient Neural Network Inference, LOW-POWER COMPUTER VISION 291-326, Chapman and Hall/CRC (2022).

By using fixed-point representations, quantization also promotes more consistent behavior across different hardware and software environments. Quantization mitigates the impact of floating-point rounding errors, leading to more predictable results during inference. Quantized models are lightweight and suitable for deployment on resource-constrained devices like mobile phones and edge devices. However, quantization still cannot fully guarantee reproducibility-which is critical for a learning-based compression.

### Activation Functions

Deep learning models use activation functions, like Rectified Linear Units (ReLU). Rasamoelina, Andrinandrasana David, et al., A Review of Activation Function for Artificial Neural Network, IN 2020 IEEE 18TH WORLD SYMPOSIUM ON APPLIED MACHINE INTELLIGENCE AND INFORMATICS (SAMI) 281-286, IEEE (2020). ReLU exacerbates irreproducibility due to its non-smooth derivative behavior.

Smooth activation functions have continuous derivatives across their entire domain, unlike ReLU. Examples include Sigmoid, Tanh, and Swish. A Smooth ReLU (SmeLU) activation function may balance reproducibility and accuracy without the complexity of other solutions. Again, there is no guarantee that activation brings fully reproducible results but activation may only mitigate the issue. However, for learning-based compression, reproducibility is indispensable.

### Rule-Based Quantization

Rule-based quantization is discussed below. An AI-based module M is assumed to be deployed to compute a scalar variable per sample. The sample is a point in point cloud compression. With a hyperprior model, the variable may be Gaussian distribution parameters, e.g., mean and variance numbers.

Let vₓ be the variable, where x is the sample. Typically, vₓ is a floating-point number as computed by the AI-based model. Though some AI-based modules may use integers as neural network weights, the output may still not be reproducible. Without losing generality, the method assumes the variable vₓ is a floating-point number, which suffers a reproducibility problem across different platforms.

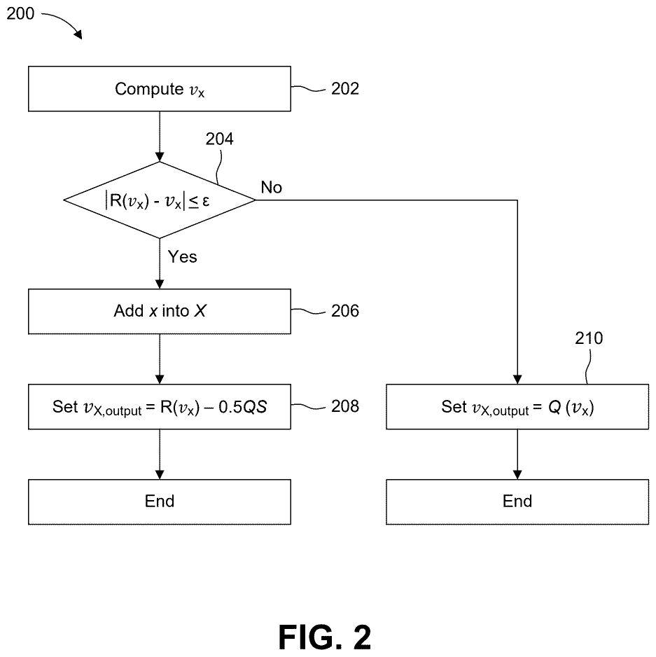

FIG. 2 is a flowchart illustrating an example encoding process according to some embodiments. For the encoder process 200 of FIG. 2, the variable vₓ is computed 202. The absolute distance of the variable vₓ from its rounded position R(vₓ) is checked 204. If the error is larger than a certain threshold ϵ, the variable is assumed to be in a “safe” range. The output is set 210 to its quantized value v_{x,output}=Q(vₓ) and the encoder process 200 ends.

Otherwise, the current point x is added 206 to set X (which is signaled to the decoder), and the variable vₓ is set 208 to v_{x,output}=R(vₓ)−0.5QS. In other words, the variable vₓ is shifted to the left of the rounded value by half of the quantization step. Then, the encoder process 200 ends.

The “left-preferred method” shown in FIG. 2 may appear less accurate because some values on the right side of the rounded value are quantized to a value not closest to the variable. However, the process 200 avoids signaling a flag fₓ.

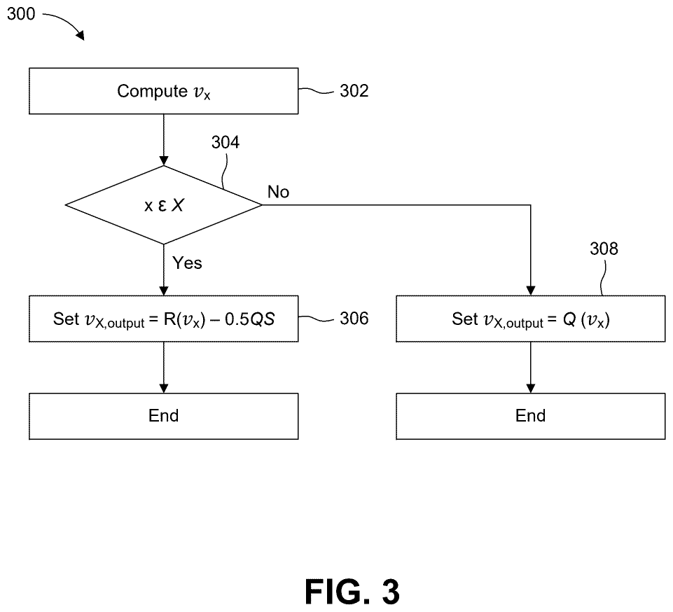

FIG. 3 is a flowchart illustrating an example decoding process according to some embodiments.

For the decoder process 300 of FIG. 3, the variable vₓ is computed 302 and a determination 304 is made on whether a current point x belongs to the set X. If the current point x does not belong to the set X, the output is set 308 to its quantized value v_{x,output}=Q(vₓ) and the decoder process 300 ends. Otherwise, the output is set 306 to v_{x,output}=R(vₓ)−0.5QS and the decoder process 300 ends.

Similar to the “left-preferred method”, a “right-preferred” quantization may be performed. If the encoder detects that the current point is in the risky range, the output is set to be v_{x,output}=R(vₓ)+0.5 for the “right-preferred method”.

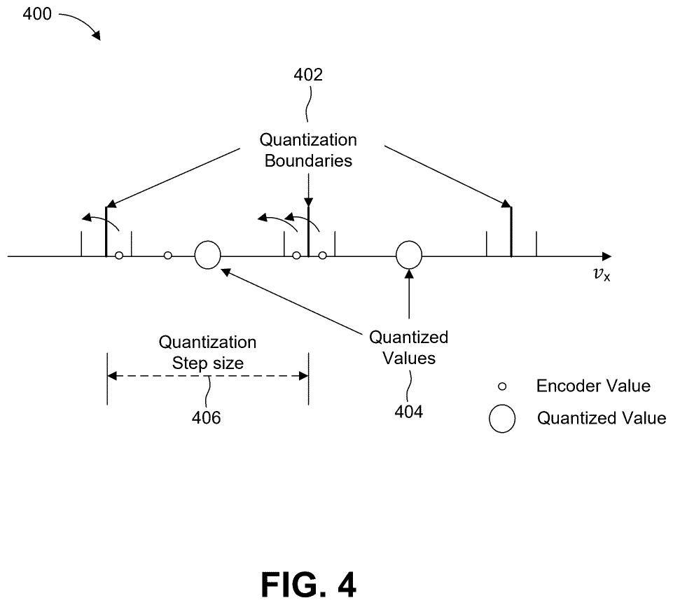

FIG. 4 is a schematic illustration showing an example matching of raw values with quantized values according to some embodiments. The process 400 shows several quantization boundaries 402 with quantized values 404 located at the halfway point between each respective set of quantization boundaries 402. Each quantization boundary 402 is separated by a quantization step size 406. FIG. 4 shows multiple scenarios in which a raw encoder value is shifted to the left, even if there is a quantized value 404 that is closer to the raw encoder value.

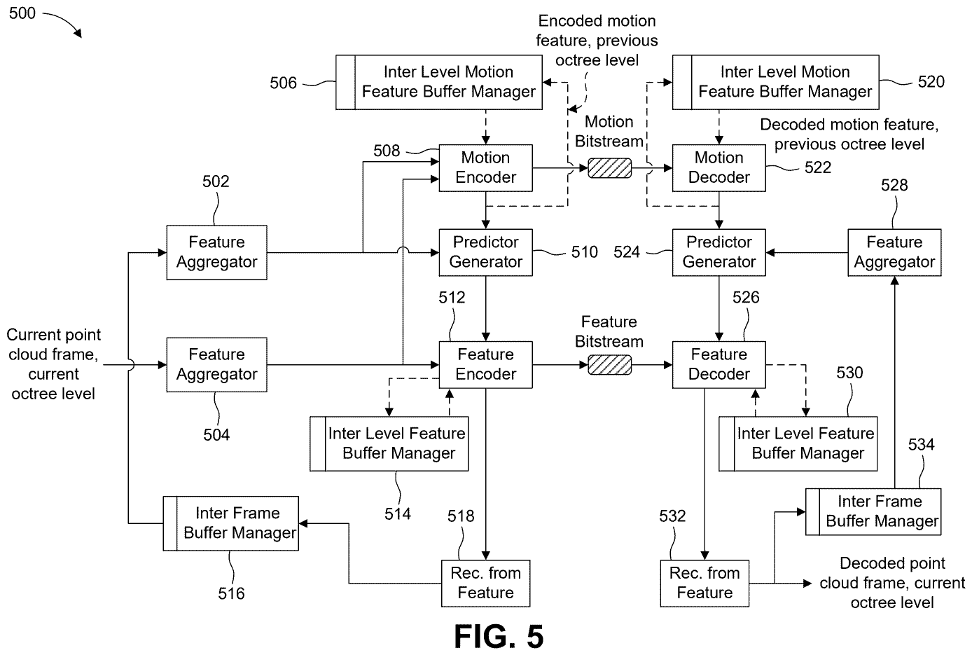

FIG. 5 is a process diagram illustrating an example processing of a level with feature-based coding in inter point cloud compression according to some embodiments. The '466 application discusses feature-based coding in a point cloud compression architecture. This architecture operates level by level on an octree structure in a hierarchical fashion, coding the coarse octree levels via lossless octree-based coding and finer octree levels via lossy feature-based coding. Moreover, both octree-based and feature-based coding schemes are supported by Inter Coding, which uses the current and the previously coded point cloud frame(s) to produce a predicted feature for the current point cloud frame.

In the example process 500 of FIG. 5, a current point cloud frame at a current octree level is input to a Feature Aggregator block 504 to produce an initial input feature map. The Feature Aggregator 502 (for some embodiments, Feature Aggregator 502 may be the same block as Feature Aggregator 504) also processes a reference point cloud frame at a current octree level to produce a reference feature map. Both feature maps are input to the Motion Encoder 508 to produce a motion feature which is encoded into a motion bitstream. The encoded motion feature is also stored to the inter level motion feature buffer manager 506. The motion feature and the reference feature map are taken by the Predictor Generator 510 to generate a predicted feature map for the current feature map. Both the predicted and the current feature map are provided to the Feature Encoder 512 to produce a current residual feature map which is encoded into the bitstream. The current residual feature map is also stored in the inter level feature buffer manager 514. For some embodiments, additional data may be received 518 from the feature encoder 512. This additional data (which may be a feature map for some embodiments) is stored to the inter frame buffer manager 516.

On the decoder side, the Motion Decoder 522 decodes the motion feature from the motion bitstream. The Motion Decoder 522 stores the decoded motion feature to the inter level motion feature buffer manager 520. The Feature Aggregator 528 processes a reference point cloud frame retrieved from the inter frame buffer manager 534 for the current octree level to produce a reference feature map. The motion feature is combined with the reference feature map to generate the predicted feature map via the Predictor Generator 524. The Feature Decoder 526 decodes the residual final feature map and combines the residual final feature map with the predicted feature map to produce a reconstructed current feature map. The residual final feature map and/or the predicted feature map may be stored to the inter level feature buffer manager 530 for some embodiments. This reconstructed feature map is used by the Rec. from Feature block 532 to produce the reconstructed current point cloud frame at a current octree level. The reconstructed current point cloud frame is stored to the inter frame buffer manager 534.

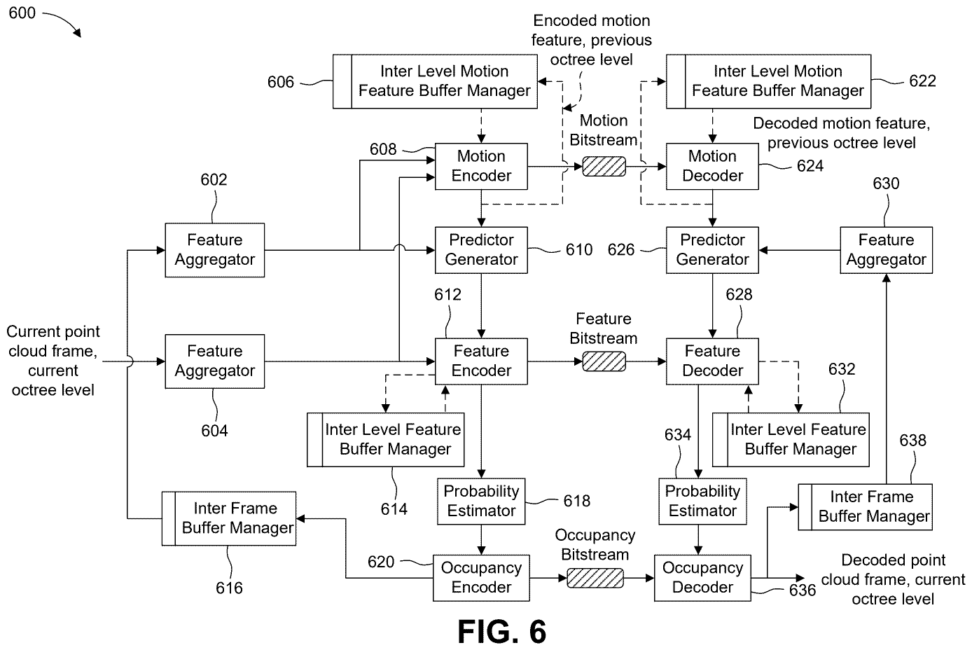

FIG. 6 is a process diagram illustrating an example processing of a level with octree-based coding in inter point cloud compression according to some embodiments. The '466 application discusses octree-based coding in a point cloud compression architecture.

In the example process 600 of FIG. 6, a current point cloud frame at a current octree level is input to a Feature Aggregator block 604 to produce an initial input feature map. The Feature Aggregator 602 (for some embodiments, Feature Aggregator 602 may be the same block as Feature Aggregator 604) also processes a reference point cloud frame at a current octree level to produce a reference feature map. Both feature maps are input to the Motion Encoder 608 to produce a motion feature which is encoded into a motion bitstream. The encoded motion feature is also stored to the inter level motion feature buffer manager 606. The motion feature and the reference feature map are taken by the Predictor Generator 610 to generate a predicted feature map for the current feature map. Both the predicted and the current feature map are provided to the Feature Encoder 612 to produce a current residual feature map which is encoded into the bitstream. The current residual feature map is also stored in the inter level feature buffer manager 614. For some embodiments, a reconstructed feature map is used by the Probability Estimator 618 to predict occupancy probabilities for each voxel at the current level. These probabilities are used by the Occupancy Encoder 620 to losslessly encode the current level occupancy of the current frame into the bitstream. The current level occupancy of the current frame is stored to the inter frame buffer manager 616.

On the decoder side, the Motion Decoder 624 decodes the motion feature from the motion bitstream. The Motion Decoder 624 stores the decoded motion feature to the inter level motion feature buffer manager 622. The Feature Aggregator 630 processes a reference point cloud frame retrieved from the inter frame buffer manager 638 for the current octree level to produce a reference feature map. The motion feature is combined with the reference feature map to generate the predicted feature map via the Predictor Generator 626. The Feature Decoder 628 decodes the residual final feature map and combines the residual final feature map with the predicted feature map to produce a reconstructed current feature map. The residual final feature map and/or the predicted feature map may be stored to the inter level feature buffer manager 632 for some embodiments. This reconstructed feature map is used by the Probability Estimator 634 to predict occupancy probabilities for each voxel at the current level. These probabilities are used by the Occupancy Decoder 636 to losslessly decode the current level occupancy of the current frame from the bitstream. The current level occupancy of the current frame is stored to the inter frame buffer manager 638.

There are two types of reproducibility, reconstruction reproducibility and decoding reproducibility. Pang, Jiahao, et al., Towards Reproducible Learning-Based Compression, IN 2024 IEEE 26TH INTERNATIONAL WORKSHOP ON MULTIMEDIA SIGNAL PROCESSING (MMSP) 1-6, IEEE (2024). Reconstruction reproducibility concerns the reproducibility of the final reconstruction, while decoding reproducibility is less strict, allowing the final reconstructions to be different across different platforms but should have similar qualities.

To ensure decoding reproducibility in the previously proposed architecture, enough protection is provided such that the entropy coding may run properly without crashing. To this end, the architectures of the Motion Encoder/Decoder, the Feature Encoder/Decoder, and the Occupancy Encoder/Decoder are updated.

### Hyperprior Synthesis in Motion and Feature Coders

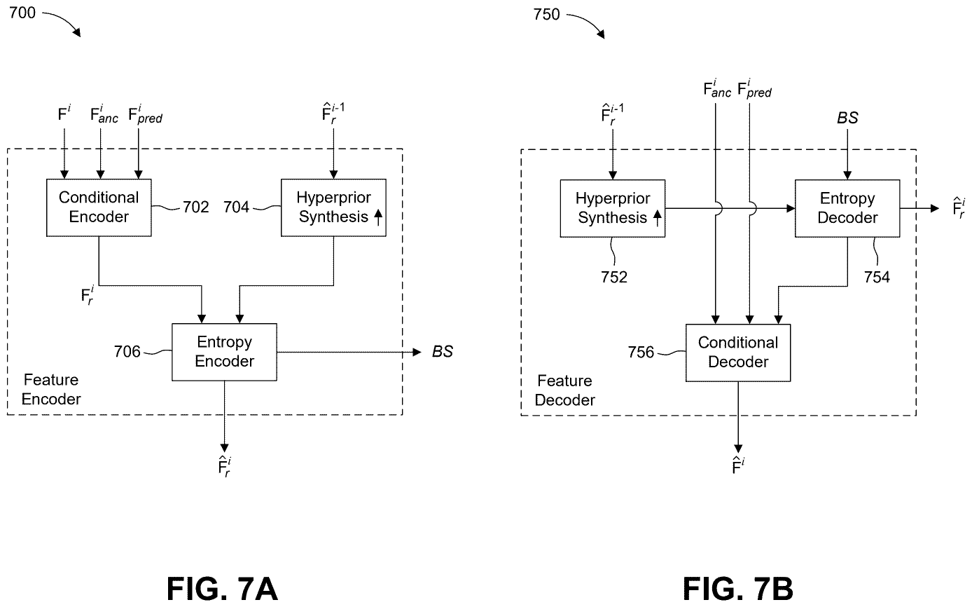

FIG. 7A is a process diagram illustrating an example feature encoder according to some embodiments. Hyperprior model is often used to assist the coding of features in learning-based compression of point clouds. FIG. 7A shows an example feature encoder 700 based on a hierarchical hyperprior model design. For the encoder, an input feature map is aggregated by a conditional encoder 702 to generate an updated feature map to be coded. The entropy encoder block 706 is an arithmetic encoder that takes distribution parameters as input. In a typical design, the distribution parameters may be Gaussian parameters, such as mean value mₓ and variance σₓ. A previously proposed hierarchical hyperprior model has only one part composed of a hyperprior synthesis block, which is implemented via some neural network layers (as opposed to two parts in a traditional hyperprior model, which additionally contains hyperprior analysis). The outputs of hyperprior synthesis block 704 are the Gaussian parameters. The Gaussian parameters are used to instruct the entropy encoder block 706.

FIG. 7B is a process diagram illustrating an example feature decoder according to some embodiments. FIG. 7B shows an example feature decoder 750 based on a hierarchical hyperprior model design. For the decoder, the hyperprior synthesis block 752 produces the Gaussian parameters. Because the synthesis block 752 is learning-based, the synthesis block 752 is run on both encoder and decoder, their output (Gaussian parameters) may have mismatches and may cause decoding problems. Hence, methods presented earlier may be applied. The hyperprior synthesis block 752 is the AI block M discussed earlier. The variable vₓ is a mean value mₓ and/or a variance σₓ. The entropy decoder block 754 is an arithmetic decoder that takes distribution parameters and the encoded bitstream as inputs. The conditional decoder 756 outputs a feature map.

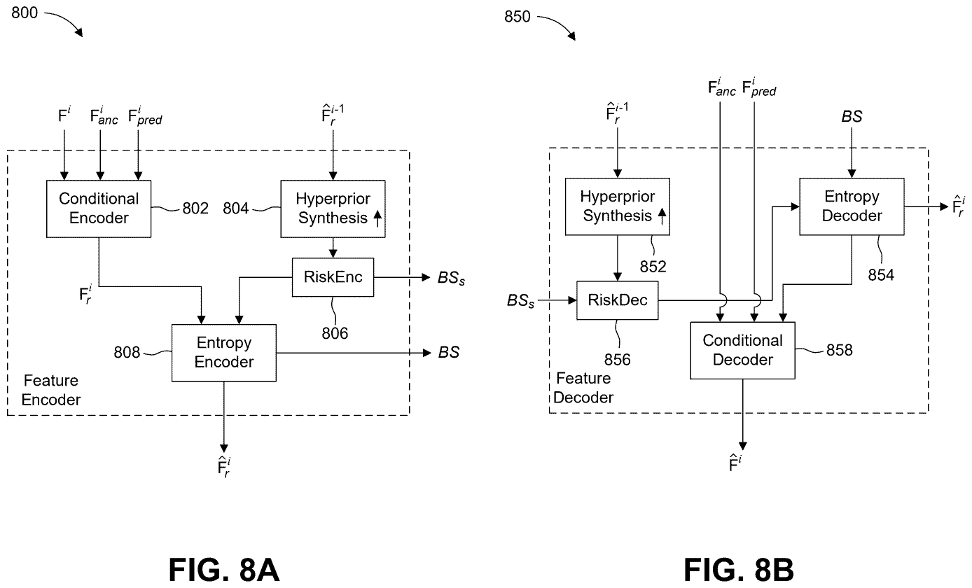

FIG. 8A is a process diagram illustrating an example feature encoder with safeguarding according to some embodiments. FIG. 8A shows an example feature encoder 800 using a hierarchical hyperprior model. The RiskEnc block 806 is introduced in the encoder 800, which may follow some of the methods described earlier. The updated mean value m′ₓ and/or variance σ′ₓ is matched between encoder and decoder given that the errors of the Gaussian parameters between the source and the target platforms are less than the threshold ϵ. The safeguard bitstream BSₛ is generated for the current level in the point cloud coding.

The mean value mₓ and/or variance σₓ output by hyperprior synthesis block 804 may be quantized inside the arithmetic encoder 808. Rather than perform uniform quantization as discussed earlier, the arithmetic encoder 808 performs non-uniform quantization, and the quantization boundaries are learned during the training stage. Therefore, the learned quantization boundaries are used directly within the RiskEnc block 806 to generate m′ₓ, variance o′ₓ, and the bitstream BSₛ.

An input feature map is aggregated by a conditional encoder 802 to generate an updated feature map to be coded. The entropy encoder block 808 is an arithmetic encoder that takes distribution parameters as inputs.

FIG. 8B is a process diagram illustrating an example feature decoder with safeguarding according to some embodiments. FIG. 8B shows an example feature decoder 850 using a hierarchical hyperprior model. The RiskDec block 856 is introduced in the decoder 850, which follows the method described earlier. The updated mean value m′ₓ and/or variance σ′ₓ is matched between encoder and decoder given that the errors of the Gaussian parameters between the source and the target platforms are less than the threshold ϵ. The received safeguard bitstream BSₛ was generated for the current level in the point cloud coding.

The mean value mₓ and/or variance σₓ output by Hyperprior Synthesis block 852 may be quantized inside the arithmetic decoder 854. Rather than perform uniform quantization as discussed earlier, the arithmetic decoder 854 performs non-uniform quantization, and the quantization boundaries are learned during the training stage. The learned quantization boundaries are used directly for the RiskDec block 856 to generate m′ₓ, and variance σ′ₓ according to the bitstream BSₛ.

The hyperprior synthesis block 852 is the AI block [symbol] discussed earlier. The entropy decoder block 854 is an arithmetic decoder that takes distribution parameters and the encoded bitstream as inputs. The conditional decoder 858 outputs a feature map.

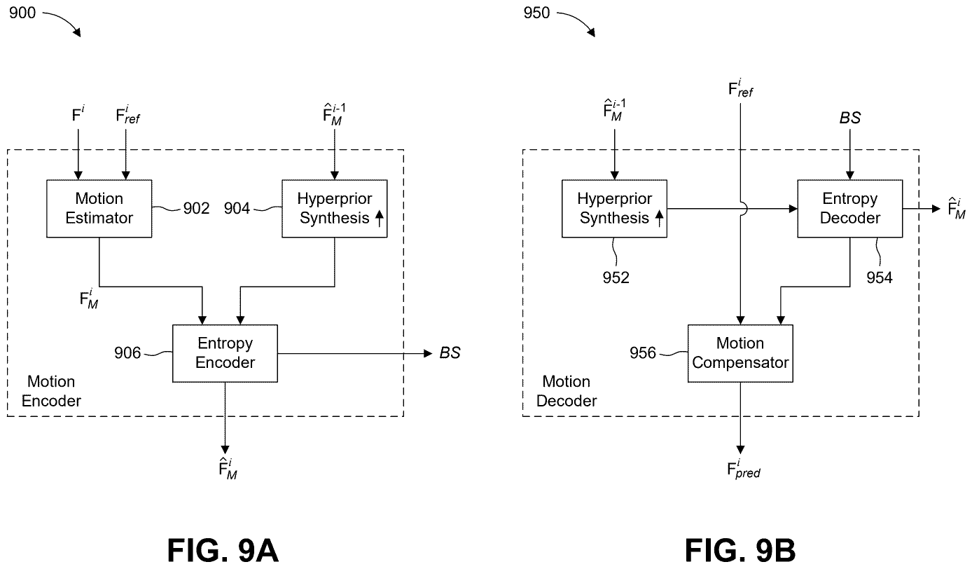

FIG. 9A is a process diagram illustrating an example motion encoder according to some embodiments. FIG. 9A shows an example motion encoder 900 based on a hierarchical hyperprior model design. For the encoder, an input feature map is aggregated by a motion estimator 902 to generate an updated feature map to be coded. The entropy encoder block 906 is an arithmetic encoder, that takes distribution parameters as input. In a typical design, the distribution parameters may be Gaussian parameters, such as mean value mₓ and variance σₓ. A previously proposed hierarchical hyperprior model has only one part composed of hyperprior synthesis block, which is implemented via some neural network layers (as opposed to two parts in a traditional hyperprior model, which additionally contains hyperprior analysis). The outputs of hyperprior synthesis block 904 are the Gaussian parameters. The Gaussian parameters are used to instruct the entropy encoder block 906.

FIG. 9B is a process diagram illustrating an example motion decoder according to some embodiments. FIG. 9B shows an example motion decoder 950 based on a hierarchical hyperprior model design. For the decoder, the hyperprior synthesis block 952 produces the Gaussian parameters. Because the synthesis block 952 is learning-based, the synthesis block 952 is run on both encoder and decoder, their output (Gaussian parameters) may have mismatches and may cause decoding problems. Hence, methods presented earlier may be applied. The hyperprior synthesis block 952 is the AI block [symbol] discussed earlier. The variable vₓ is a mean value mₓ and/or a variance σₓ. The entropy decoder block 954 is an arithmetic decoder that takes distribution parameters and the encoded bitstream as inputs. The conditional decoder 956 outputs a feature map.

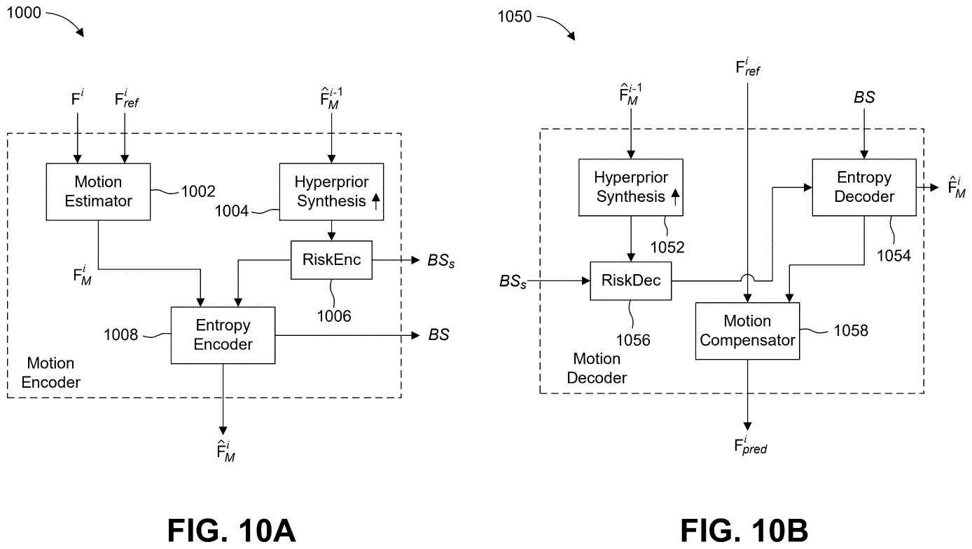

FIG. 10A is a process diagram illustrating an example motion encoder with safeguarding according to some embodiments. FIG. 10A shows an example motion encoder 1000 using a hierarchical hyperprior model. The RiskEnc block 1006 is introduced in the encoder 1000, which follows the method described earlier. The updated mean value m′, and/or variance o′ is matched between encoder and decoder given that the errors of the Gaussian parameters between the source and the target platforms are less than the threshold ϵ. The safeguard bitstream BSₛ is generated for the current level in the point cloud coding.

The mean value mₓ and/or variance σₓ output by hyperprior synthesis block 1004 may be quantized inside the arithmetic encoder 1008. Rather than perform uniform quantization as discussed earlier, the arithmetic encoder 1008 performs non-uniform quantization, and the quantization boundaries are learned during the training stage. Therefore, the learned quantization boundaries are used directly within the RiskEnc block 1006 to generate m′ₓ, variance σ′ₓ, and the bitstream BSₛ.

An input feature map is aggregated by a conditional encoder 1002 to generate an updated feature map to be coded. The entropy encoder block 1008 is an arithmetic encoder that takes distribution parameters as inputs.

FIG. 10B is a process diagram illustrating an example motion decoder with safeguarding according to some embodiments. FIG. 10B shows an example motion decoder 1000 using a hierarchical hyperprior model. The RiskDec block 1056 is introduced in the decoder 1050, which follows the method described earlier. The updated mean value m′ₓ and/or variance σ′ₓ is matched between encoder and decoder given that the errors of the Gaussian parameters between the source and the target platforms are less than the threshold ϵ. The received safeguard bitstream BSₛ was generated for the current level in the point cloud coding.

The mean value mₓ and/or variance σₓ output by Hyperprior Synthesis block 1052 may be quantized inside the arithmetic decoder 1054. Rather than perform uniform quantization as discussed earlier, the arithmetic decoder 1054 performs non-uniform quantization, and the quantization boundaries are learned during the training stage. The learned quantization boundaries are used directly for the RiskDec block 1056 to generate m′ₓ, and variance o′ₓ according to the bitstream BSₛ.

The hyperprior synthesis block 1052 is the AI block M discussed earlier. The entropy decoder block 1054 is an arithmetic decoder that takes distribution parameters and the encoded bitstream as inputs. The conditional decoder 1058 outputs a feature map.

### Probability Estimator in Occupancy Coder

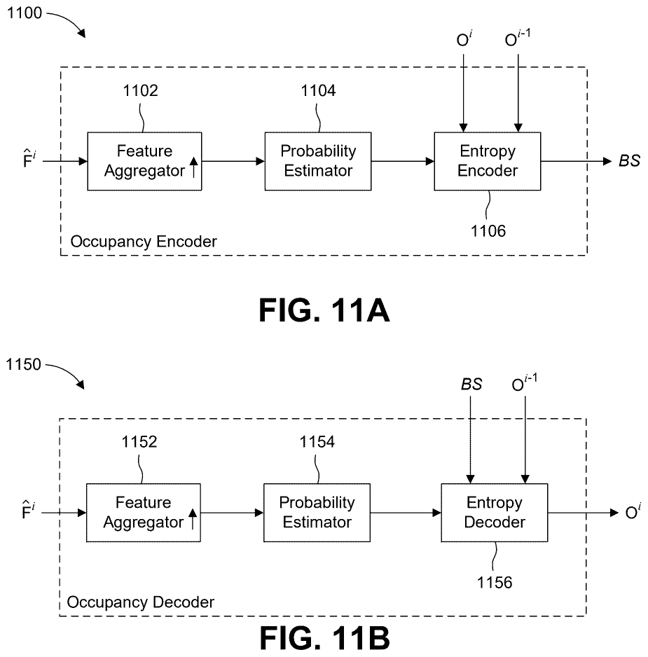

FIG. 11A is a process diagram illustrating an example occupancy encoder according to some embodiments. FIG. 11B is a process diagram illustrating an example occupancy decoder according to some embodiments.

As shown in the deep octree coding scenario of FIGS. 11A and 11B, an AI block Probability Estimator 1104, 1154 is used to predict the probability of a child voxel to be occupied from a aggregated feature map generated by a Feature Aggregator 1102, 1152. This Probability Estimator block 1104, 1154 is typically run on both encoder 1100 and decoder 1150. The probability is to guide the entropy encoding/decoding also shown in FIGS. 11A and 11B. In this case, any mismatch in the probability values between the encoder and decoder may lead to a completely wrong decoding of an octree voxel. This is a serious error and will bring very poor point cloud reconstruction quality. In the encoder 1100, the Probability Estimator block 1104 uses the output of the Probability Estimator block 1104 and the occupancy for the current and the previous level to generate an encoded bitstream. In the decoder 1150, the output of the Probability Estimator block 1154, the previous level occupancy, and the encoded bitstream are used by an Entropy Decoder 1156 to decode the occupancy.

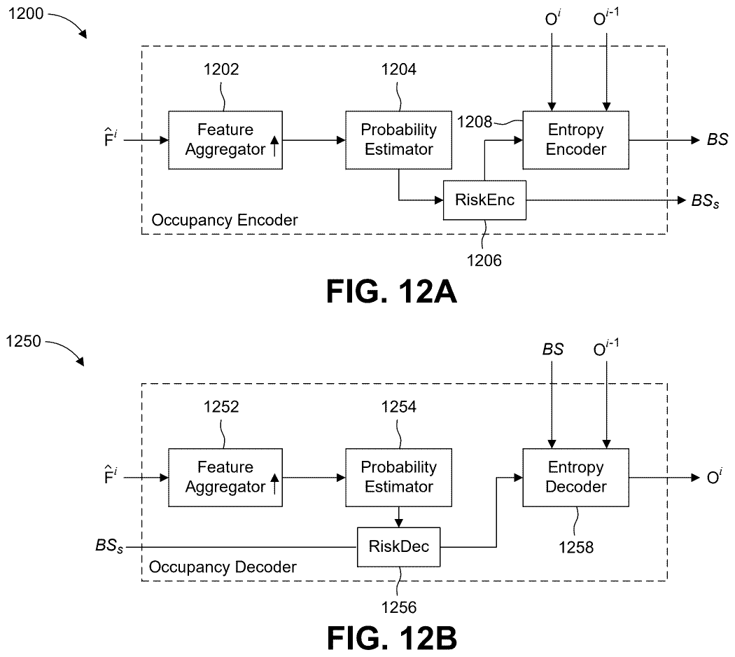

FIG. 12A is a process diagram illustrating an example occupancy encoder with safeguarding according to some embodiments. FIG. 12B is a process diagram illustrating an example occupancy decoder with safeguarding according to some embodiments.

The embodiments presented above may be used in deep octree coding. As shown in the deep octree coding scenario of FIGS. 12A and 12B, an AI block Probability Estimator 1204, 1254 is used to predict the probability of a child voxel to be occupied from a aggregated feature map generated by a Feature Aggregator 1202, 1252. This Probability Estimator block 1204, 1254 is typically run on both encoder 1200 and decoder 1250. The probability is to guide the entropy encoding/decoding also shown in FIGS. 12A and 12B. In the encoder 1200, the Probability Estimator block 1204 uses the output of the Probability Estimator block 1204 and the occupancy for the current and the previous level to generate an encoded bitstream. In the decoder 1250, the output of the Probability Estimator block 1254, the previous level occupancy, and the encoded bitstream are used by an Entropy Decoder 1256 to decode the occupancy.

Earlier in this application, the probability pₓ was treated as vₓ. This will lead to a modified encoding and decoding diagrams shown in FIGS. 12A and 12B, respectively. The RiskEnc block 1206 and RiskDec block 1256 are introduced in the encoder 1200 and decoder 1250, respectively. The updated probability p′ₓ will then be exactly matched between encoder and decoder. The safeguard bitstream newly generated is labeled as BSₛ for the current octree level.

Compatibility with Other Technologies

Since smaller ϵ may reduce the overhead, quantizing neural network weights as shown above may be used to decrease the potential maximum error max_err so that a smaller ϵ may be used without risks. For different target GPUs, the safeguard bitstream may be generated respectively. When a target GPU is known, the size of the safeguard bitstream is reduced by selecting a similar GPU.

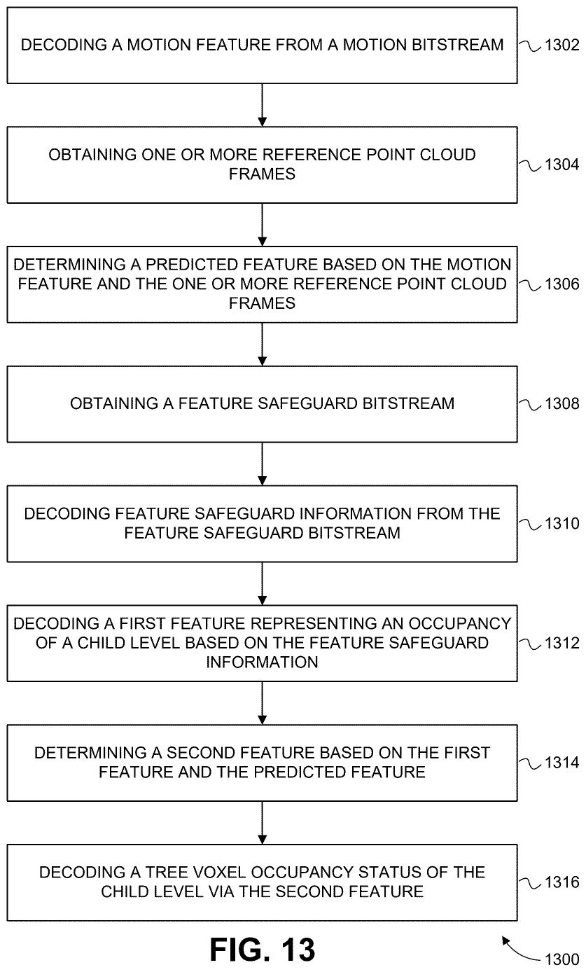

FIG. 13 is a flowchart illustrating an example decoding process according to some embodiments. For some embodiments, an example process 1300 may include decoding 1302 a motion feature from a motion bitstream. For some embodiments, the example process 1300 may further include obtaining 1304 one or more reference point cloud frames. For some embodiments, the example process 1300 may further include determining 1306 a predicted feature based on the motion feature and the one or more reference point cloud frames. For some embodiments, the example process 1300 may further include obtaining 1308 a feature safeguard bitstream. For some embodiments, the example process 1300 may further include decoding 1310 feature safeguard information from the feature safeguard bitstream. For some embodiments, the example process 1300 may further include decoding 1312 a first feature representing an occupancy of a child level based on the feature safeguard information. For some embodiments, the example process 1300 may further include determining 1314 a second feature based on the first feature and the predicted feature. For some embodiments, the example process 1300 may further include decoding 1316 a tree voxel occupancy status of the child level via the second feature.

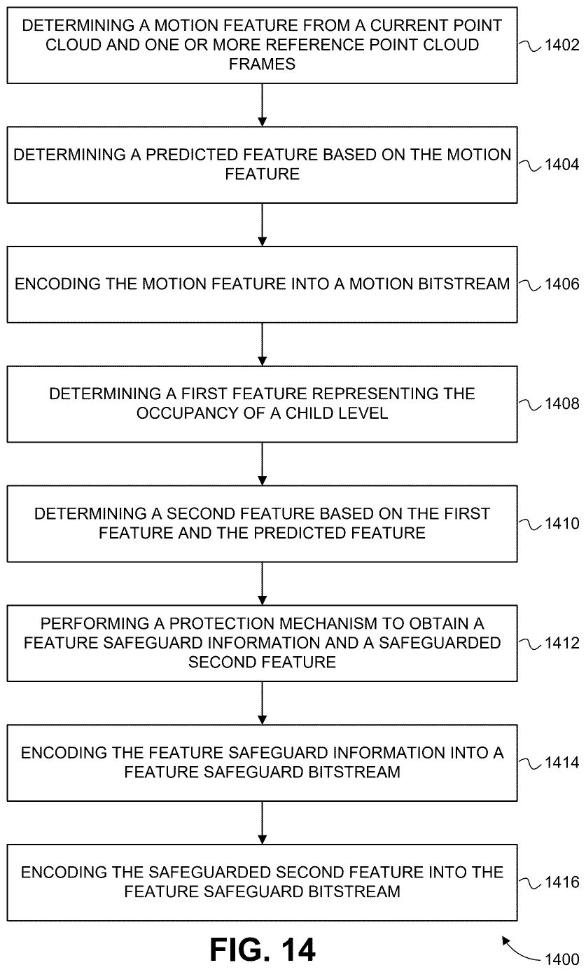

FIG. 14 is a flowchart illustrating an example encoding process according to some embodiments. For some embodiments, an example process 1400 may include determining 1402 a motion feature from a current point cloud and one or more reference point cloud frames. For some embodiments, the example process 1400 may further include determining 1404 a predicted feature based on the motion feature. For some embodiments, the example process 1400 may further include encoding 1406 the motion feature into a motion bitstream. For some embodiments, the example process 1400 may further include determining 1408 a first feature representing the occupancy of a child level. For some embodiments, the example process 1400 may further include determining 1410 a second feature based on the first feature and the predicted feature. For some embodiments, the example process 1400 may further include performing 1412 a protection mechanism to obtain a feature safeguard information and a safeguarded second feature. For some embodiments, the example process 1400 may further include encoding 1414 the feature safeguard information into a feature safeguard bitstream. For some embodiments, the example process 1400 may further include encoding 1416 the safeguarded second feature into the feature safeguard bitstream.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: decoding a motion feature from a motion bitstream; obtaining one or more reference point cloud frames; determining a predicted feature based on the motion feature and the one or more reference point cloud frames; obtaining a feature safeguard bitstream; decoding feature safeguard information from the feature safeguard bitstream; decoding a first feature representing an occupancy of a child level based on the feature safeguard information; determining a second feature based on the first feature and the predicted feature; and decoding a tree voxel occupancy status of the child level via the second feature.

Some embodiments of the first example method may further include: obtaining a motion safeguard bitstream; decoding motion safeguard information from the motion safeguard bitstream, wherein decoding the motion feature from the motion bitstream is based on the motion safeguard information.

Some embodiments of the first example method may further include: obtaining a probability safeguard bitstream; and decoding probability safeguard information from the probability safeguard bitstream, wherein decoding the tree voxel occupancy status of the child level via the second feature is based on the probability safeguard information.

For some embodiments of the first example method, the feature safeguard information includes learned quantization boundary versions of distribution parameters associated with a point cloud.

For some embodiments of the first example method, the feature safeguard information includes learned quantization boundaries.

For some embodiments of the first example method, decoding the motion feature is based on one or more non-uniform quantization rules.

For some embodiments of the first example method, decoding the tree voxel occupancy status of the child level includes: estimating occupancy probabilities using the second feature; obtaining an occupancy bitstream; and performing arithmetic decoding of the occupancy bitstream based on the estimated occupancy probabilities.

Some embodiments of the first example method may further include obtaining a probability safeguard bitstream, wherein performing arithmetic decoding of the occupancy bitstream is further based on the probability safeguard bitstream.

A first example apparatus in accordance with some embodiments may include: a processor; and a memory storing instructions operative, when executed by the processor, to cause the apparatus to: decode a motion feature from a motion bitstream; obtain one or more reference point cloud frames; determine a predicted feature based on the motion feature and the one or more reference point cloud frames; obtain a feature safeguard bitstream; decode feature safeguard information from the feature safeguard bitstream; decode a first feature representing an occupancy of a child level based on the feature safeguard information; determine a second feature based on the first feature and the predicted feature; and decode a tree voxel occupancy status of the child level via the second feature

A second example method in accordance with some embodiments may include: determining a motion feature from a current point cloud and one or more reference point cloud frames; determining a predicted feature based on the motion feature; encoding the motion feature into a motion bitstream; determining a first feature representing the occupancy of a child level; determining a second feature based on the first feature and the predicted feature; performing a protection mechanism to obtain a feature safeguard information and a safeguarded second feature; encoding the feature safeguard information into a feature safeguard bitstream; and encoding the safeguarded second feature into the feature safeguard bitstream.

Some embodiments of the second example method may further include: performing a protection mechanism to obtain motion safeguard information and a safeguarded motion feature; encoding the motion safeguard information into a motion safeguard bitstream; and encoding the safeguarded motion feature into a bitstream.

Some embodiments of the second example method may further include: performing a protection mechanism to obtain probability safeguard information and a safeguarded occupancy probability; encoding the probability safeguard information into a probability safeguard bitstream; and encoding a tree voxel occupancy status of the child level based on the safeguarded occupancy probability.

For some embodiments of the second example method, the feature safeguard information includes learned quantization boundary versions of distribution parameters associated with the current point cloud.

For some embodiments of the second example method, the feature safeguard information includes learned quantization boundaries.

For some embodiments of the second example method, the protection mechanism includes using learned quantization boundaries associated with a non-uniform quantization.

For some embodiments of the second example method, encoding the motion feature includes: performing a non-uniform quantization of the motion feature; and encoding the quantized motion feature into the motion bitstream.

Some embodiments of the second example method may further include encoding the occupancy status of the child level voxel by encoding the second feature into the bitstream.

For some embodiments of the second example method, encoding the occupancy status of the child voxels includes: determining a third feature based on the second feature and the predicted feature; determining occupancy probabilities of the child voxels to be encoded; and encoding the occupancy status of the child voxels with the occupancy probabilities in an occupancy bitstream using an arithmetic encoder.

For some embodiments of the second example method, encoding of the occupancy status is further based on a safeguarded occupancy probability.

For some embodiments of the second example method, the protection mechanism is based on assessed risk associated with one or more features of the current point cloud.

One or more embodiments provide a computer program including instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods include one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present application may refer to “determining” various pieces of information. Determining information may include one or more of, for example, estimating, calculating, predicting, or retrieving (e.g., from memory) the information.

The present application may refer to “accessing” various pieces of information. Accessing information may include one or more of, for example, receiving, retrieving (e.g., from memory), storing, moving, copying, calculating, determining, predicting, or estimating the information. Similarly, the present application may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present application or the following claims. Although features and elements are described herein in particular combinations, those of ordinary skill in the art will appreciate that such features or elements may be used alone or in any combination with the other features and elements. It is understood, therefore, that the overall teachings of the present application are not limited to the particular embodiments, implementations, and examples disclosed herein, but are intended to cover variations, modifications, and alternatives as defined by the appended claims and any and all equivalents thereof.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various numeric values may be used in the present application, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
decoding a motion feature from a motion bitstream;
obtaining one or more reference point cloud frames;
determining a predicted feature based on the motion feature and the one or more reference point cloud frames;
obtaining a feature safeguard bitstream;
decoding feature safeguard information from the feature safeguard bitstream;
decoding a first feature representing an occupancy of a child level based on the feature safeguard information;
determining a second feature based on the first feature and the predicted feature; and
decoding a tree voxel occupancy status of the child level via the second feature.

2. The method of claim 1, further comprising:
obtaining a motion safeguard bitstream;
decoding motion safeguard information from the motion safeguard bitstream,
wherein decoding the motion feature from the motion bitstream is based on the motion safeguard information.

3. The method of claim 1, further comprising:
obtaining a probability safeguard bitstream; and
decoding probability safeguard information from the probability safeguard bitstream,
wherein decoding the tree voxel occupancy status of the child level via the second feature is based on the probability safeguard information.

4. The method of claim 1, wherein the feature safeguard information comprises learned quantization boundary versions of distribution parameters associated with a point cloud.

5. The method of claim 1, wherein the feature safeguard information comprises learned quantization boundaries.

6. The method of claim 1, wherein decoding the motion feature is based on one or more non-uniform quantization rules.

7. The method of claim 1, wherein decoding the tree voxel occupancy status of the child level comprises:
estimating occupancy probabilities using the second feature;
obtaining an occupancy bitstream; and
performing arithmetic decoding of the occupancy bitstream based on the estimated occupancy probabilities.

8. The method of claim 7,
further comprising obtaining a probability safeguard bitstream,
wherein performing arithmetic decoding of the occupancy bitstream is further based on the probability safeguard bitstream.

9. An apparatus comprising:
a processor; and
a memory storing instructions operative, when executed by the processor, to cause the apparatus to:
decode a motion feature from a motion bitstream;
obtain one or more reference point cloud frames;
determine a predicted feature based on the motion feature and the one or more reference point cloud frames;
obtain a feature safeguard bitstream;
decode feature safeguard information from the feature safeguard bitstream;
decode a first feature representing an occupancy of a child level based on the feature safeguard information;
determine a second feature based on the first feature and the predicted feature; and
decode a tree voxel occupancy status of the child level via the second feature.

10. A method comprising:
determining a motion feature from a current point cloud and one or more reference point cloud frames;
determining a predicted feature based on the motion feature;
encoding the motion feature into a motion bitstream;
determining a first feature representing the occupancy of a child level;
determining a second feature based on the first feature and the predicted feature;
performing a protection mechanism to obtain a feature safeguard information and a safeguarded second feature;
encoding the feature safeguard information into a feature safeguard bitstream; and
encoding the safeguarded second feature into the feature safeguard bitstream.

11. The method of claim 10, further comprising:
performing a protection mechanism to obtain motion safeguard information and a safeguarded motion feature;
encoding the motion safeguard information into a motion safeguard bitstream; and
encoding the safeguarded motion feature into a bitstream.

12. The method of claim 10, further comprising:
performing a protection mechanism to obtain probability safeguard information and a safeguarded occupancy probability;
encoding the probability safeguard information into a probability safeguard bitstream; and
encoding a tree voxel occupancy status of the child level based on the safeguarded occupancy probability.

13. The method of claim 10, wherein the feature safeguard information comprises learned quantization boundary versions of distribution parameters associated with the current point cloud.

14. The method of claim 10, wherein the feature safeguard information comprises learned quantization boundaries.

15. The method of claim 10, wherein the protection mechanism comprises using learned quantization boundaries associated with a non-uniform quantization.

16. The method of claim 10, wherein encoding the motion feature comprises:
performing a non-uniform quantization of the motion feature; and
encoding the quantized motion feature into the motion bitstream.

17. The method of claim 10, further comprising encoding the occupancy status of the child level voxel by encoding the second feature into the bitstream.

18. The method of claim 17, wherein encoding the occupancy status of the child voxels comprises:
determining a third feature based on the second feature and the predicted feature;
determining occupancy probabilities of the child voxels to be encoded; and
encoding the occupancy status of the child voxels with the occupancy probabilities in an occupancy bitstream using an arithmetic encoder.

19. The method of claim 18, wherein encoding of the occupancy status is further based on a safeguarded occupancy probability.

20. The method of claim 10, wherein the protection mechanism is based on assessed risk associated with one or more features of the current point cloud.
